(19) United States
(12) Patent Application Publication
(10) Pub. No.: US 2015/0105975 A1
(43) Pub. Date: Apr. 16, 2015

(54) Electropneumatic Towing Stabilizer System

(71) Applicant: Alexander Russell Dunn, Penn Valley, CA (US)

(72) Inventor: Alexander Russell Dunn, Penn Valley, CA (US)

(21) Appl. No.: 14/055,729

(22) Filed: Oct. 16, 2013

(51) Int. Cl. B60D 1/32; B60D 1/58

(52) U.S. Cl. CPC B60D 1/322; B60D 1/58
USPC 701/36; 188/266.5; 280/455.1

(57) ABSTRACT

An automatic stability control system is provided which determines the lateral acceleration and lateral velocity of a towed trailer and forward velocity of the tow vehicle. When the lateral acceleration and/or velocity of the towed trailer exceeds predetermined values established for the current forward velocity of the tow vehicle, the stability system meters a gas, such as compressed air, from a gas reservoir into at least one cylinder of a pair of buffer arms each comprising a piston that is pivotably attached to the towed trailer and a cylinder which is pivotably attached to the tow vehicle. Gas is metered into one or both buffer arm cylinders until the lateral acceleration and lateral velocity of the towed vehicle meets or is below predetermined values established for the forward velocity of the tow vehicle.

### BACKGROUND OF THE INVENTION

One of the common and dangerous traffic accident types involves a vehicle towing a trailer, often by a driver who may be unfamiliar with the dynamics of towing. Some of these incidents involve a motion of the towed trailer which is commonly referred to as fishtailing whereby the trailer oscillates laterally while being towed, even in a substantially straight forward vector, and these oscillations can become amplified and result in the trailer exceeding the lane boundaries or other hazardous conditions. In cases where a driver applies the vehicle brakes too aggressively, the trailer's forward momentum can become translated into a lateral movement known as jackknifing whereby the trailer can swing around the trailer hitch attachment until it impacts one side of the tow vehicle. Jackknifing is a common problem in semi tractor-trailer rigs, particularly in low traction conditions like ice and snow where insufficient friction makes even trailer brakes (applied alternately as described in U.S. Pat. No. 7,226,068) of little use in preventing or stopping a fishtailing or jackknifing trailer motion. U.S. Pat. No. 8,046,147 describes a signal processing method for computing how to stabilize a car-trailer combination, but it fails to provide a detailed means for influencing the relative positions or forces of the car and trailer in order to effect stabilization.

Numerous schemes for addressing the problem of trailer fishtailing and jackknifing have been suggested, yet the problem persists for both commercial towing systems and for personal use towing systems, such as rental trailers, boat trailers, and the like. Traffic accidents and fatalities due to trailer fishtailing and jackknifing continue to accrue every year in the US and worldwide. Clearly, there is a need for an apparatus and method for reducing trailer fishtailing and/or jackknifing that can be applied in either a commercial or personal use towing setting. The present invention addresses that need.

U.S. Pat. Nos. 7,226,068 and 4,023,864 describe a method for using trailer braking forces to stabilize the fishtailing motion of a trailer; as mentioned above, such a system requires conditions of adequate traction between the wheels and the road surface to operate effectively and often inclement weather or other road conditions (e.g., oil in the lane) or trailer wheel bearing seizures do not allow brake-mediated systems to function as designed. U.S. Pat. No. 7,175,194 describes an anti-jackknifing device suitable for commercial semi trailers that utilize a kingpin as the towing attachment point whereby the engagement arms of the device limit the angle of the trailer to the tractor to a predetermined angle; this system does not prevent fishtailing at lesser angles than the predetermined angle and also suffers from having a fixed angle limit which does not vary with the forward speed of the tow vehicle, whereas in higher speed towing even low-angle oscillatory movements in fishtailing can be hazardous. U.S. Pat. No. 7,540,523 describes an anti jackknifing trailer hitch assembly which relies on one singular predetermined articulation angle to limit the maximum angular movement of the trailer relative to the tow vehicle; this approach fails in several respects, including but not limited to the facts that it (1) limits the maximum angle between the trailer yoke and tow vehicle in low speed conditions when it may be necessary to employ large angles for turning sharp corners, backing, parking, and the like of trailers, and (2) does not address the problem of lesser angle displacements which can still remain problematic in high-speed fishtailing oscillations when lateral forces can be high even when displaced angles are less than the maximum allowed by the predetermined articulation angle of the described anti jackknifing trailer hitch assembly. Thus, the hitch system of U.S. Pat. No. 7,540,523 ignores the fact that the maximum permissible articulation angle varies with forward speed and other circumstances, thus the allowed articulation angle should be variable—the present invention addresses this fundamental flaw of prior systems. U.S. Pat. No. 8,244,442 describes a system that can input both vehicle and trailer motion data and then apply brakes or certain other stated vehicle stability means to control trailer and vehicle motions, however the system is complex and requires a deep integration into the electronics of the tow vehicle and trailer control subsystems, making it impractical for use except if integrated into the basic vehicle and trailer designs by the manufacturer or would require substantial post-manufacturing modifications—which are not amenable to personal use towing systems such as rental trailers that must accommodate use on numerous vehicle makes, models, and dimensions. U.S. Pat. No. 8,326,504 describes a trailer sway intervention system that utilizes trailer yoke angle displacement rate (yaw rate) to differentially apply braking forces to trailer wheels to stabilize vehicle-trailer swaying; like all brake-based systems, this suffers from the problem that road conditions, wheel bearing seizure, or tire problems defeat the utility of brakes to effect a sufficient stabilizing force to adequately control the trailer motion. U.S. Patent Publications US2003/0067139 and US2005/0212256 both describe trailer control schemes that rely on semi tractor-trailer kingpin towing systems and use a rudimentary device either actuated by the driver or a simplistic T-shaped retaining bar to control maximum allowable angle between the trailer and the tractor; these either require input from the driver at times when the driver may be otherwise occupied in an imminent accident situation, or unaware, and/or they are not able to vary the allowable maximum subtended angle with vehicle speed or other parameters, such as trailer weight.

Thus, despite the numerous schemes described above by others, there exists a clear need in the art for a simple trailer stability system that (1) can prevent both fishtailing and jack-knifing, (2) can adapt to a wide variety of trailer and tow vehicle combinations, (3) can dynamically adjust the maximum allowed angular displacement (either absolute angle or angle displacement rate/yaw rate), and (4) is automatic and does not require driver monitoring and inputs. The present invention provides these and other features and benefits. The patents and publications cited above are incorporated herein in their entirely for all purposes as if they were reproduced here verbatim and with their drawings.

### SUMMARY OF THE INVENTION

The present system, apparatus, and method provide for the control and stabilization of a trailer towed behind a tow vehicle so that the lateral movements of the trailer relative to the tow vehicle are constrained to within predetermined acceptable limits. These limits may be fixed, but typically vary with vehicle forward speed, detected velocity vector change(s), acceleration/deceleration, or other parameters or variables that may be selected by the practitioner. The system is substantially insensitive to road conditions or other traction or similar factors that limit the usefulness of trailer braking systems. The system detects when the lateral trailer movements exceed predetermined limits under the detected velocity conditions and apply forces to the trailer and tow vehicle via one or more pneumatically controllable buffer arms which are attached at one end to the tow vehicle and at the other end to the trailer; to increase leverage, the buffer arm attachment points on the tow vehicle are typically located distal to the long axis of the trailer yoke, such that a buffer arm may be attached, for example, with one end attached to the righthand area of the tow vehicle trailer and the other end attached to the right front area of the trailer frame. When the system detects lateral motion of the trailer that exceeds the predetermined limit based on the present vehicle velocity, compressed gas is applied from a pressurized gas reservoir via gas lines into the buffer arm cylinder to apply force on the piston and thus resistive force on the trailer via the piston's pivotable attachment to the trailer such that the force resists and/or dampens the further lateral motion of the trailer in the direction that it had exceeded the predetermined limit. Generally, a metered amount of gas is applied and then the system is allowed to resample the rate of lateral motion and the vehicle velocity using sensors. If additional damping forces are required, further aliquots of metered gas can be applied to one or more buffer arms. Generally, the system employs two buffer arms, one on each side of the trailer yoke, so that the pneumatic system can apply compressed gas alternately to each buffer arm as the trailer may move from one side of the subtended yaw angle to the other side. Gas is applied in discrete amounts and this is done repeatedly until the trailer motion is suppressed and the lateral motion subtended angle and/or rate of change of the subtended angle is reduced to within predetermined acceptable limits relative to the tow vehicle velocity. Optionally, after the lateral movement of the trailer has been controlled, the system may then vent the gas pressure in the buffer arm(s) to depressurize it and equilibrate it to the ambient atmospheric pressure and thus reset the system to the original base conditions. In this way, the electropneumatic towing stability system monitors and controls trailer sway movements, damping out excessive motion, and preventing fishtailing and jackknife situations while allowing the trailer and tow vehicle to make sharp turns as low speed, such as is needed in many situations, like backing the trailer, negotiating sharp (e.g., right angle) turns are low speed, and going through drive-through window driveways at fast food establishments frequented by casual vacationers who may be towing a camping trailer, boat, or rental trailer. Once the undesirable motion is controlled, the system can vent the buffer arm cylinder pressure to the ambient atmosphere and the system is reset. This may be done either automatically or may require user intervention as a means of informing the user (e.g., the tow vehicle driver) of a possible unsafe condition of the towing rig combination or his driving pattern which needs to be addressed and remedied.

An automatic stability control system is provided which determines the lateral acceleration and lateral velocity of a towed trailer and forward velocity of the tow vehicle. When the lateral acceleration and/or velocity of the towed trailer exceeds predetermined values established for the current forward velocity of the tow vehicle, the stability system meters a gas, such as compressed air, from a gas reservoir into at least one cylinder of a pair of buffer arms each comprising a piston that is pivotably attached to the towed trailer and a cylinder which is pivotably attached to the tow vehicle. Gas is metered into one or both buffer arm cylinders until the lateral acceleration and lateral velocity of the towed vehicle meets or is below predetermined values established for the forward velocity of the tow vehicle. In a variation, the system uses the rate of change of the subtended angle and/or the subtended angle between the trailer yoke and the tow vehicle rear bumper as a parameter to compare with the forward velocity of the tow vehicle, and if the subtended angle and/or its rate of change exceeds predetermined values established for the current forward velocity of the tow vehicle, compressed gas is applied into the cylinder(s) of one or both buffer arms until the subtended angle and/or its rate of change falls below predetermined values established for the forward velocity of the tow vehicle. Either a single or alterating application of compressed gas to the buffer arm cylinders damps out the trailer lateral movement to dampen oscillatory movements which may otherwise cause fishtailing or jackknifing of the trailer.

The present invention comprises a lateral motion sensor (16) that detects lateral movement of a trailer (15) and/or the lateral acceleration of the trailer, and a vehicle speed sensor (7) that inputs the forward velocity of the tow vehicle (10) (in some embodiments this may be a single integrated sensor combining (16) and (7) into one sensor). A computer (8) inputs the detected amount and/or rate of lateral movement of the trailer and the forward speed or acceleration of the tow vehicle and compares the detected measurement(s) using a predetermined table of allowable lateral movement and/or lateral acceleration rates versus forward speed (and optionally also forward acceleration) stored in the computer memory; if the amount or rate of lateral movement of the trailer exceeds the predetermined allowed movement angle or distance or lateral acceleration, then the computer actuates a valve block (11) to open a valve for a predetermined disbursement period or gas amount to pressurize a gas line (12a and/or 12b) from a pressurized gas reservoir (9) transferring the gas to the buffer arm cylinder (5) of a buffer arm unit (3), thereby increasing the pressure inside the cylinder and increasing the force against piston (6) which transmits that force to the appropriate side of the trailer via a pivotable trailer attachment (2); this force thereby resisting further movement of the trailer in the lateral direction in which its movement exceeded the predetermined allowed movement angle or distance or lateral acceleration.

The invention provides an apparatus comprising a buffer arm unit (3) that comprises a cylinder (5) that can be pivotably attached to a tow vehicle or a trailer, a piston (6) that is movable within the interior (lumen) of the cylinder and forms a substantially gastight seal with the interior walls of the cylinder and which can be pivotably attached to a trailer or tow vehicle, a gas line (12a or 12b) providing fluid communication between the interior of the cylinder and a valve block (11), a valve block (11) which is actuated by electrical, mechanical, or hydraulic means under authority of a computer (8) which receives inputs from a lateral motion sensor (16) and a forward velocity sensor (7), and a pressurized gas reservoir (9). When a valve on the valve block is opened on the valve block, pressurized air from the gas reservoir is in open fluid communication via the gas tube with the interior of the cylinder; the valve may be transiently opened for a time period (tᵥₐₗᵥₑ) to allow a predetermined amount of gas to pass from the gas reservoir to the interior of the cylinder; alternatively the valve may be opened until a predetermined pressure in the gas line or cylinder interior is detected by a pressure sensor, at which time the valve is commanded to shut.

In a variation, the apparatus comprises a pair of buffer arms (3), a valve block (11) which can be actuated by computer (8) to deliver pressurized gas from reservoir (9) to either a rightside gas line (12b) or a leftside gas line (12a) individually, but typically not both at the same time. The valve block (11) may also be actuated to vent or otherwise depressurize leftside gas line (12a) and rightside gas line (12b) to the atmosphere either individually or at the same time. In a specific embodiment, the gas reservoir is an air tank and the gas is air; a further variation of this includes an air compressor which can maintain a predetermined pressure with the air tank and can often be operated by a pressure sensor and may be driven electrically by connection to the tow vehicle electrical system, by separate dedicated battery, or by other means known in the art. In a specific embodiment, the gas in the gas reservoir is pressurized to at least 150 pounds per square inch (PSI) and in some variations to at least 300 PSI or in excess of 400 PSI up to as much as 1000 PSI. Alternate embodiments avoid using a compressor and instead the gas reservoir is pre-pressurized; in some cases using an inert, unreactive gas such as for example and not limitation, nitrogen, argon, or carbon dioxide.

In a genus of embodiments of the electropneumatic towing stabilizer system, the lateral motion sensor (16) detects the movement and/or absolute displacement of the piston (6) relative to the cylinder (5) and the computer samples this sensor information over time intervals allowing the computer to translate the information, often using standard trigonometric methods, into a rate of lateral motion of the trailer (15) or a rate of increase of the subtended angle (“yaw angle”) between the current position of the trailer yoke and that of the trailer yoke when the trailer is perfectly aligned with the tow vehicle to follow a straight path; this subtended angle is designated φ and shown in FIG. 2. The computer also inputs the tow vehicle velocity from a vehicle speed sensor (7) which is also sampled at time intervals, often substantially simultaneously with the sampling of the lateral movement and/or absolute displacement of the piston. The computer then compares the computed lateral motion (either as lateral velocity, lateral acceleration, or both) and/or the rate of increase in the subtended angle and/or the absolute scalar value of the subtended angle with a predetermined allowable limit value specified for the detected forward velocity of the tow vehicle, and if the computed value of any of the variables of the rate of lateral movement (or the absolute scalar value of the subtended angle φ) exceeds the predetermined allowable limit value for that variable at the detected forward speed, then the computer issues an order to open a valve on the valve block (11) to transfer gas from the pressurized gas reservoir (9) via a gas line (12a or 12b) to the cylinder (5) of the buffer arm (3) on the side of the tow vehicle towards which the trailer is pivoting, thereby increasing the pressure inside said cylinder and imparting a force upon piston (6) of said buffer arm, and said piston thereby transfers the force to the pivotable trailer attachment point (2) whereby this transduced force (“counterforce”) dampens or counters the lateral motion of the trailer. In this manner, the trailer sway is countered or dampened by the buffer system. In most embodiments, the valve is opened by the computer for a predetermined charging interval (CI) or until a predetermined gas line pressure (GLP) is achieved to meter a limited amount of gas from the reservoir (9) into the interior of the cylinder (5). The motion detection—pressurization cycle continues iteratively until the lateral motion (and/or absolute subtended angle φ) is reduced below the predetermined allowable limit value for that variable at the detected forward speed. Preferably, the system samples the variables rapidly at short time intervals and relatively small gas pulses are sent through the valve block and gas line to achieve a smooth increase in the damping force applied to the trailer in a gradual manner, which interval lengths can be selected by the practitioner using calibration and as desired for smooth operation. Subsequent to the application of counterforce to the trailer with one buffer arm, said buffer arm may either remain pressurized or a valve in said valve block may be actuated to vent the buffer arm's cylinder interior to the atmosphere and initiate equilibration with ambient atmospheric pressure. Preferably, the buffer arm cylinder is vented to the atmosphere after the cycle of dampening force application—often the valve block is actuated to effect the venting once the computer has determined that the lateral motion of the trailer has been halted or reversed (for example, if the subtended angle φ is decreasing rather than increasing).

The invention provides a method for countering an undesired lateral motion of a towed trailer, said method comprising the steps of:

detecting a lateral motion variable of a trailer and a forward speed of a tow vehicle or said trailer;

determining if said detected lateral motion variable exceeds a predetermined allowable limit value specified for the detected forward speed;

applying a pressurized gas from a pressurized gas reservoir to the cylinder interior of a buffer arm attached to the said towed trailer thereby applying a force to counter said undesired lateral motion if said detected lateral motion variable exceeds said predetermined allowable limit value. In an embodiment, when the detected forward speed exceeds 30 miles per hour (mph), the detected lateral motion variable is the yaw angle, φ, and the predetermined allowable limit value of φ is in the range of 10 to 45 degrees, preferably in the range of 20 to 35 degrees, and often 30 degrees.

In various embodiments of said method, the lateral motion variable is at least one of: lateral velocity, lateral acceleration, rate of increase in the subtended angle and/or the absolute scalar value of the subtended angle, or any combination thereof. In various embodiments of the method, the gas reservoir includes a compressor unit to pressurize the reservoir using compressed air; a variant employs a pressure sensor to maintain a predetermined reservoir gas pressure; a variant uses tow vehicle electrical power supplied by the tow vehicle electrical system to operate the compressor; a variant uses a reservoir which contains a pressurized non-reactive gas selected from: helium, neon, argon, nitrogen, xenon, or carbon dioxide; a variant uses a gas reservoir that can sustain an internal pressure of at least 300 PSI or in excess of 400 PSI up to as much as 1000 PSI; a variation uses a valve block wherein the valves are actuated electrically via command from the computer; a variation uses two buffer arms with each arm on opposite sides of the long axis of the tow vehicle-trailer combination; a variant comprises a sensor which measures lateral motion directly and without reference to a piston position relative to the cylinder; a variant comprises an integrated sensor that detects both forward speed and lateral motion variable simultaneously and transmits said forward speed and lateral motion variable to the computer either via wire or wirelessly. A variation of the method includes the further step of actuating a valve to vent the interior of the buffer arm cylinder to the atmosphere following the step of applying a pressurized gas; in one variation, the step of venting is performed only after the lateral motion variable is at or below the predetermined allowable limit value specified for the detected forward speed. A variation of the method comprises a weatherproof buffer arm comprising a metal cylinder, which may often be a steel, stainless steel, chrome-plated steel, nickel-plated steel, aluminum, titanium, or other suitable metal or alloyed metal selected by those in the art according to the desired application. A variation of the method comprises a piston comprising a non-metal composite, which may often be a carbon-fiber composite or ceramic; or it may consist of carbon fiber or ceramic. In a class of embodiments, the piston forms a substantially gastight seal with the interior cylinder wall with a metallic piston ring affixed to the piston. In a variation, the interior of the cylinder is lubricated with a weather-resistant lubricant which may comprise: an automotive oil or grease, mineral oil, synthetic oil, a molybdenum-based lubricant, white grease, a lithum-based lubricant, a silicon-based lubricant, or other suitable lubricant selected by the practitioner. In a class of embodiments, the time interval for sampling the lateral motion variable and the vehicle speed is less than 3 seconds and more than 10 microseconds, preferably less than 1 second and more than 100 microseconds, and often less than 0.3 seconds and more than 50 milliseonds.

The method can include the further step of inputting to the computer data comprising at least one of: the estimated or actual weight of the trailer, the length of the trailer yoke, the weight of the tow vehicle, the length of the tow vehicle, the length of the trailer, the make, model, and year of the tow vehicle, the number of axles of the trailer, specific identification of a rental trailer model, or the like. The computer data is input to the computer so that the computer may apply the appropriate look-up table or algorithm to utilize or calculate the predetermined allowable limit value for that lateral motion variable(s) at various vehicle speeds so that the limits are appropriate for the specific tow vehicle and trailer combination.

In a variation of the invention, the buffer arm cylinder is attached to a pivotable trailer attachment point and the piston is attached to a pivotable tow vehicle attachment point. In such variation, it is typical that the computer, gas reservoir, and valve block are attached to the trailer and not to the bumper or other component of the tow vehicle. In an embodiment, the system principally resides on the trailer and is powered by an electrical umbilical to the tow vehicle's electrical system. In some embodiments, attachable pivotable tow vehicle attachment points are provided which can be attached to a tow vehicle frame, bumper, undercarriage, or other suitable load-bearing attachment surface; often these attachable tow vehicle attachment points are also removable, and may employ clamps as a means of attachment, although other removable means known in the art may also be used.

The invention also provides a kit comprising: at least one buffer arm, a computer, a valve block, a pressurized or pressurizable gas reservoir, at least one gas line, a computer, and a sensor. In a class of embodiments, the kit also provides at least one attachable pivotable tow vehicle attachment point, which may also be removable, and in some variations may comprise a clamp that attaches to the tow vehicle bumper, frame, undercarriage, or other suitable load-bearing attachment surface. Some kits comprise attachable pivotable trailer attachment points, either in place of or in addition to an attachable pivotable tow vehicle attachment point. Some such kits will further comprise an instructional booklet describing how to attach and utilize the kit components to form a electropneumatic towing stabilizer system; said instructional booklet may further comprise tables or algorithms which can be used to adjust the system for a variety of tow vehicle lengths and/or weights and/or trailer lengths, weights, and/or number of axles. A preferred genus of said kit comprises two buffer arms and two attachable pivotable attachment points for a tow vehicle, a trailer, or both.

The invention provides a trailer with a electropneumatic towing stabilizer system comprising a trailer, at least one and preferably two buffer arms, a computer, a valve block, a gas line (one for each buffer arm), a gas reservoir, and a sensor. Some embodiments will further comprise attachable pivotable attachment points that can be attached to a tow vehicle, in some variations by clamping to a tow vehicle bumper, frame, chassis, or undercarriage. In some embodiments the sensor will comprise two separable sensor units: a vehicle speed sensor unit and a lateral motion sensor unit.

These together with other objects and advantages which will become subsequently apparent reside in the details of construction and operation as more fully hereinafter described and claimed, reference being had to the accompanying drawings forming a part hereof, wherein like numerals refer to like parts throughout, whether specified by number or referenced with words only. Numerous variations and substitutions will be apparent and understood by those skilled in the art and will not each be individually described in detail herein.

### BRIEF DESCRIPTION OF THE DRAWINGS

FIG. 1 is a diagram of an exemplary electropneumatic towing stabilizer system. A tow vehicle (10) provides motive force to pull a trailer (15) via the trailer yoke (14) which attaches to a trailer hitch (13) that allows the trailer to pivot in an arc behind the tow vehicle. A buffer arm (3) is comprised of a cylinder (5) and a piston (6) which can move axially along the interior of the cylinder and forms a substantially gastight seal with the interior wall of the cylinder, usually with a piston ring (not shown). A buffer arm (3) is attached at one end to the tow vehicle at a pivotable tow vehicle attachment point (4) and at the other end to a pivotable trailer attachment point (2). In the embodiment shown, the buffer arm cylinder is attached proximal to the tow vehicle and the piston is attached to the trailer distally to the tow vehicle, although in other embodiments this can be reversed. In the embodiment shown, a computer (8), a vehicle speed sensor (7), a gas reservoir (9), and an electrically actuated valve block (11) are attached to a tow vehicle bumper (1) which also comprises pivotable tow vehicle attachment points (4), and a trailer hitch (13). The system shown also comprises a lateral motion sensor (16) and gas lines (12a and 12b) which provide a fluid communication between the valve block (11) and a left and right buffer arm cylinder, respectively.

FIGS. 2(a) and 2(b) show a electropneumatic towing stabilizer system in a straight towing path (FIG. 2(a)) and in a condition of lateral motion to the left (FIG. 2(b)). The subtended angle of lateral motion (“yaw angle”) φ is the angle between the trailer yoke (14) and an imaginary line where the trailer yoke would be in a straight towing path (shown with a dotted line).

FIG. 3 is a simplified block diagram showing the operation of a electropneumatic towing stabilizer system from the base state to the point at which the detected lateral motion of the trailer exceeds a predetermined value for the vehicle speed. In this exemplary embodiment, the lateral motion sensor detects the movement of the piston (6) by the displacement and/or rate of displacement of the piston shaft that connects to the attachment point at one end and the piston crown at the other.

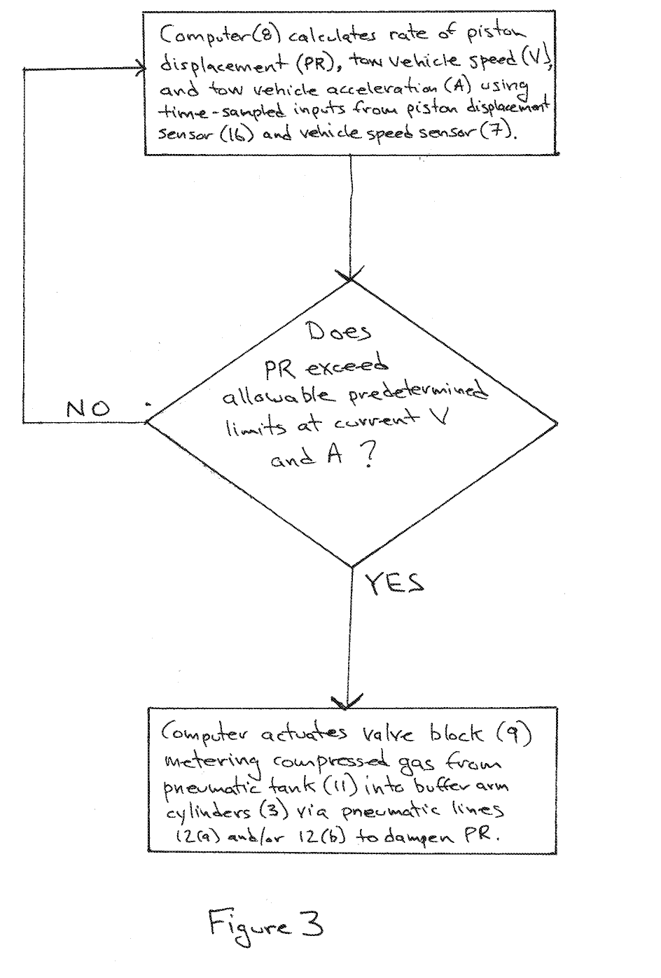

### DESCRIPTION OF THE PREFERRED EMBODIMENT

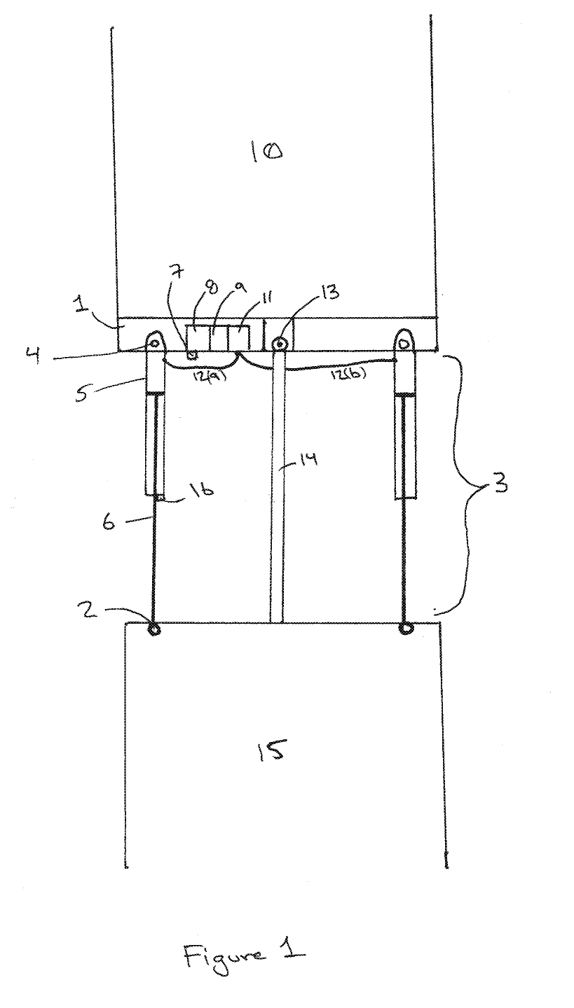

Referring to FIG. 1, the present invention comprises a lateral motion sensor (16) that detects lateral movement of a trailer (15) and/or the lateral acceleration of the trailer, and a vehicle speed sensor (7) that inputs the forward velocity of the tow vehicle (10) (in some embodiments this may be a single integrated sensor combining (16) and (7) into one sensor). A computer (8) inputs the detected amount and/or rate of lateral movement of the trailer and the forward speed or acceleration of the tow vehicle and compares the detected measurement(s) using a predetermined table of allowable lateral movement and/or lateral acceleration rates versus forward speed (and optionally also forward acceleration) stored in the computer memory; if the amount or rate of lateral movement of the trailer exceeds the predetermined allowed movement angle or distance or lateral acceleration, then the computer actuates a valve block (11) to open a valve for a predetermined disbursement period, pressure, or gas amount to pressurize a gas line (12a and/or 12b) from a pressurized gas reservoir (9) transferring the gas to the buffer arm cylinder (5) of a buffer arm unit (3), thereby increasing the pressure inside the cylinder and increasing the force against piston (6) which transmits that force to the appropriate side of the trailer via a pivotable trailer attachment (2); this force thereby resisting further movement of the trailer in the lateral direction in which its movement exceeded the predetermined allowed movement angle or distance or lateral acceleration. Typically, after a pulse of gas is applied to produce a counterforce to oppose the direction of excess lateral movement, the valve block (11) is actuated by the computer to open a valve to vent the gas pressure inside the buffer arm cylinder via the gas line to the ambient atmosphere, thereby resetting the system. In some embodiments, a plurality of cycles of pressurizing the buffer arm cylinder, each additively adding gas to the cylinder interior, takes place before any venting is performed, thereby adding gas and/or pressure to the buffer arm cylinder in a stepwise, additive manner to smoothly apply counterforce to damp the lateral motion of the trailer.

In the base condition, wherein no undesired lateral motion is detected by the computer, in other words a normal, stable towing condition, the valve block (11) vents gas lines (12a and 12b) to the ambient atmosphere allowing the cylinder interiors to intake and exhaust gas (e.g., air) as needed as the trailer engages in lateral motions which are within the predetermined limits, such as during a normal, controlled turn or backing of the trailer. In this base condition, the buffer arms do not substantially restrict the lateral motions of the trailer so long as the rate of lateral motion and/or absolute lateral motion (e.g., yaw angle) does not exceed predetermined values for the detected vehicle speed and/or vehicle acceleration (e.g., such as deceleration in a panic stop).

The lateral motion sensor (16) may comprise an optical movement sensor (such as is used on optical computer mouses and input pens) that detects: (a) lateral motion over the road bed, (b) the position of the piston shaft (the absolute displacement of the piston shaft relative to the cylinder, which may be based on registration markings on the shaft or the computer maintaining a running variable of piston position based on continuous tracking of movements), and/or (c) lateral acceleration (as calculated by the computer based on sequential intervals of tracking lateral motion via (a) or (b) above. Some embodiments may detect lateral acceleration based on detection via accelerometer. In some embodiments, particularly when an optical sensor is used to measure lateral motion via detection of optical signals reflected from the roadbed, the lateral motion sensor may incorporate or also serve as the vehicle speed sensor (7) and may serve to detect forward vehicle speed and in some variations tow vehicle acceleration also.

The lateral motion data and the vehicle speed data detected by the sensor(s) are input to the computer (8), generally via a wired connection or a short-range wireless transmission such as an infrared link, a low-power radio link, or other electromagnetic data link methodology. The computer typically receives such inputs in discrete time intervals as data sampling and computes the lateral and forward motion variables based on the sampled data over one or more time intervals. The computer contains a program which compares the detected lateral motion, either as direction and rate of lateral motion, rate of increase in subtended angle (yaw angle), and/or absolute lateral motion (subtended angle/yaw angle), with the detected forward tow vehicle speed and/or tow vehicle acceleration and determines if the detected lateral motion exceeds a predetermined value specified for the detected forward vehicle speed and/or acceleration. If the detected lateral motion exceeds that predetermined value (limit value), then the computer begins to activate a lateral motion suppression system to stabilize the trailer motion and damp excessive lateral motion. A basis for this motion suppression is the pressurization of the buffer arm on the side in which the excessive lateral motion is detected; thus if the trailer is moving too rapidly and/or too far to the left, the left side buffer arm is pressurized with gas to provide a counterforce to the left side of the trailer via the left buffer arm attachment point on the trailer. A similar effect is produced on the right side buffer arm if the computer detects the trailer moving too rapidly and/or too far to the right.

The base condition is defined as when the trailer movement is within the allowed predetermined limits for lateral motion at the vehicle speed. In the base condition, the valve block (11) has valves set open to vent the gas line(s) to atmospheric pressure, allowing the buffer arms to intake and expel gas from the atmosphere into and out of their cylinders as needed while the tow vehicle-trailer combination maneuvers, such as in allowable condition low-speed turns or modest side-to-side motions during towing which will cause the piston(s) to travel inwardly and outwardly from the respective buffer arm cylinder(s). Upon detecting a lateral motion that exceeds the predetermined limit for the detected tow vehicle speed, the computer transmits an actuating signal to the valve block (11) to actuate a valve to close venting of the gas line attached to the buffer arm on the side of the trailer in which the lateral motion has exceeded the limit and open fluid communication between the pressurized gas reservoir (which is maintained above atmospheric pressure) and said buffer arm via said gas line, thereby adding gas and pressure to the cylinder interior of said buffer arm and exerting a force upon the piston that transduces the force to the trailer attachment point on the side of the trailer in which direction the excessive lateral motion was detected. Generally, the valve is open to allow a predetermined amount of gas or until a detected pressure in the gas line or cylinder is achieved; this can be accomplished by opening the valve for a predetermined time. The applied counterforce to oppose the lateral motion in the direction in which the predetermined lateral motion parameter was exceeded may be insufficient with only a single application of gas. If the computer detects that the lateral motion remains in excess of allowed limits, then one or more subsequent cycles of pressurization of the buffer arm on the side to which the excessive lateral motion is directed can be applied. Once the computer detects that the lateral motion has fallen within allowable limits, then no further pressurization cycles are performed and the computer actuates the valve to vent the pressurized buffer arm to the atmospheric pressure, and the system returns to the base state.

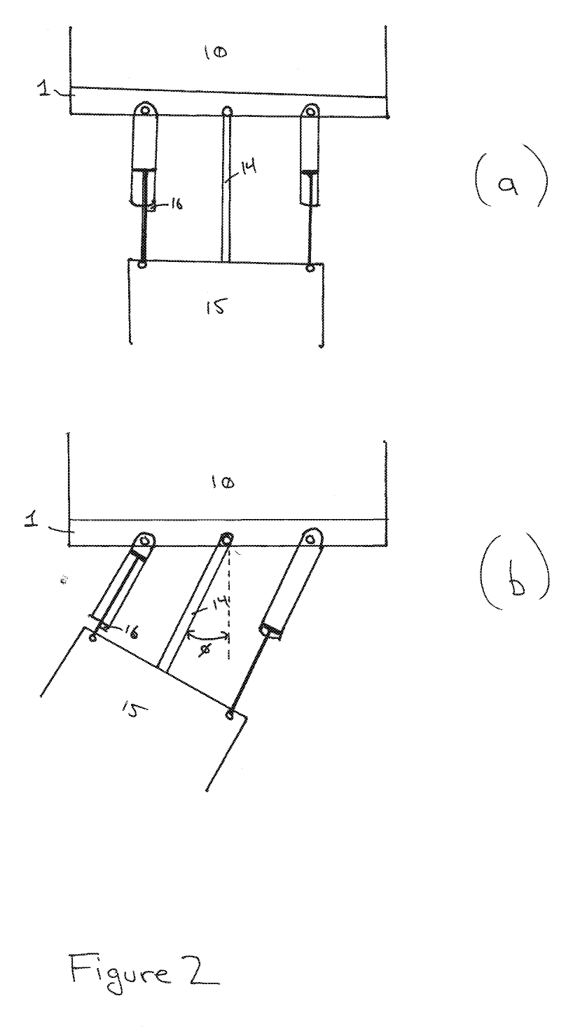

In many cases of fishtailing, the counterforce applied to one side of the trailer may not be sufficient to arrest the fishtailing motion, and so it is often desirable to employ the buffer arm of the invention in pairs, with one buffer arm on either side of the trailer yoke as shown in FIG. 1 and FIGS. 2(a) and 2(b). In such cases, after a counterforce is applied on one side of a fishtailing trailer, the trailer may swing back in the other lateral direction and also exceed a predetermined lateral motion limit in the opposite direction, activating the computer to actuate one or more pressurization cycle(s) of the buffer arm on the other side (i.e., the side to which the trailer is now swinging) until that lateral motion is brought to within the allowable limit values. In this way, a trailer can be prevented from exceeding predetermined lateral motion limits and a fishtailing motion can be arrested before a dangerous condition occurs. An air compressor is often used in conjunction with the system in order to replenish the pressurization of the gas reservoir and maintain it's effectiveness in delivering gas pressure to the buffer arm cylinder(s).

In one embodiment, a buffer arm unit (3) is attached to the tow vehicle bumper (1) at a pivotable tow vehicle attachment point (4) and to the trailer at a pivotable trailer vehicle attachment point (2). The principle towing force is transduced from the tow vehicle (10) through the trailer yoke (14) to the trailer (15), with the trailer yoke attached to the tow vehicle using a standard pivotable trailer hitch (13). The buffer arm comprises a cylinder (5) which forms a substantially gastight seal with an interior piston (6) and has a port in fluid communication with a gas line (12a or 12b) which is in fluid communication to an electrically or hydraulically actuated valve block (11). The cylinder port is typically at the distal portion of the cylinder furthest from the piston so as to maximize the travel of the interior piston while still allowing the port to remain in fluid communication with the interior (lumen) of the cylinder when the piston is maximally pushed into the cylinder. A lateral motion sensor (16) reports the movement of the piston relative to the cylinder, typically by transmitting this information to the computer (8) either via wire or wirelessly, and the lateral motion sensor uses any art-known means of detecting and reporting the movement of the piston, such as an optical sensor using a diode laser such as is commonly used in computer input devices like mice, trackballs, and pens. The computer may keep a running tally of the piston position by a summation of prior detected movements and/or the sensor may detect index marks on the piston stem or elsewhere to note the position of the piston crown relative to the top (or head) of the cylinder.

A buffer arm unit (3) comprises a cylinder (5), a piston (6), and a gas line (12a or 12b), with a hole, loop, or other fastening device at each end to enable linkage to an attachment point on the tow vehicle or trailer. A cylinder is often made of metal, such as for example and not limitation, aluminum, a carbon steel, a stainless steel, an other-alloyed steel, chromium steel, chrome-plated steel, nickel-plated steel, or other metal which can be shaped or forged into a cylinder which is suitable for all-weather use. In most cases, the interior wall of the cylinder may be machined and optionally cross-hatched suitably for forming a gastight seal with a piston with or without a piston ring, and generally including a lubricant. Those skilled in the art can select a suitable lubricant for the desired application and may consider expected ambient temperature range, moisture levels, anticipated dirt and dust conditions, and the like. To reduce potential contamination of the lubricant, the bottom of the cylinder is often capped with an end cap that contains a central hole through which the piston stem passes. Suitable lubricants include but are not limited to: mineral oils, synthetic oils, molybdenum greases, lithium greases, and the like. The piston is often made of a metal such as aluminum, a carbon steel, a stainless steel, an other-alloyed steel, chromium steel, chrome-plated steel, nickel-plated steel, or other metal which can be shaped or forged into a piston which is suitable for all-weather use. In some weight-saving embodiments, the piston may be a composite material such as a carbon-fiber composite or ceramic. In many embodiments, the piston contains a circumferential recess for a piston ring which is fitted around the piston circumference to form a gastight seal with the cylinder interior wall. Those skilled in the art will select the material for the piston ring and the number of piston rings to employ in their discretion from the suitable materials, including but not limited to: cast iron and helical spring backed cast iron or steel. In an embodiment, the cylinder interior wall comprises a layer of halfnium (IV) carbide applied by chemical vapor deposition and a piston ring comprises an outer layer of halfnium (IV) carbide allied by chemical vapor deposition. Such halfnium carbide coatings reduce wear and scoring of the cylinder wall and piston ring(s) to provide a longer life to the buffer arm unit, particularly if there is no lubricant or the lubricant fails or becomes substantially ineffective.

The computer (8) may further comprise a memory device that records data that can include, for example and not limitation, time and date, forward speed, forward acceleration, lateral velocity, lateral angle (φ), rate of change of lateral angle, direction of lateral motion, lateral acceleration, direction of lateral acceleration, GPS coordinates (if supplied by a separate GPS unit or a GPS sensor integrated into the computer), or other vehicle or trailer parameter. The memory device can be non-volatile memory so as to store the information even when the computer loses power.

The computer (8) also has an interface to allow input and export of data and program code. The interface may comprise a data port, such as a USB, Firewire, or wireless communication system, or may comprise a data entry pad or keyboard, such as a numeric 0-9 keypad, and LED display, or similar. One use of such data input devices is to input data to adjust the system performance for various combinations of tow vehicle and trailer, weather conditions, weight and balance data, and/or to adjust the allowable limits for lateral motion at various forward speeds and/or accelerations (e.g. a look-up table).

A variation of the invention employs a buffer arm which lacks a pivotable attachment point on one end and instead has a cushioned blunt end on the end which lacks the pivotable attachment point. In this variation, the proper positioning of the buffer arm is maintained by an attachment that connects the buffer arm to the trailer yoke to maintain the buffer arm substantially parallel to the trailer yoke; the attachment can comprise a metal rod or bar that is perpendicular to the long axis of the trailer yoke and the long axis of the buffer arm and is firmly attached to both to maintain the yoke and buffer arm in parallel.

While the invention is described above in terms of specific embodiments, it is not understood to be limited thereto, but is limited only as indicated by the following claims.

The invention as claimed is:

1. An electropneumatic towing stabilizer system comprising an apparatus comprising:
a buffer arm unit comprising:
a cylinder that can be pivotably attached to a tow vehicle or a trailer; and
a piston that is movable within the interior of the cylinder and forms a substantially gastight seal with the interior wall of the cylinder and capable of being pivotably attached to a trailer or tow vehicle;
a gas line providing fluid communication between a valve block and the interior of said cylinder at a position between a cylinder head and said piston;
a valve block which can be actuated by electrical, mechanical, or hydraulic means under authority of a computer;
a sensor which can detect lateral motion and forward motion;
a computer which receives input from said sensor and commands actuation of said valve block; and
a pressurized gas reservoir in fluid communication with said valve block.

2. The electropneumatic towing stabilizer system of claim 1, wherein the apparatus comprises two buffer arm units with a first buffer arm unit attached left of the trailer yoke and a second buffer arm unit attached right of the trailer yoke.

3. The electropneumatic towing stabilization system of claim 1, wherein the apparatus further comprises an air compressor.

4. The electropneumatic towing stabilizer system of claim 1, wherein the apparatus comprises two buffer arm units with a first buffer arm unit attached left of the trailer yoke and a second buffer arm unit attached right of the trailer yoke and an air compressor.

5. The electropneumatic towing stabilizer system of claim 1, wherein said sensor comprises a lateral motion sensor and a separate vehicle speed sensor.

6. The electropneumatic towing stabilizer system of claim 1, further comprising an attachable and removable pivotable attachment point that can be removably attached to a tow vehicle on a bumper, frame member, or undercarriage.

7. The electropneumatic towing stabilizer system of claim 1, further comprising a trailer.

8. The electropneumatic towing stabilizer system of claim 1, further comprising a trailer and a tow vehicle.

9. A method for countering an undesired lateral motion of a towed trailer, said method comprising the steps of:
detecting a lateral motion variable of a trailer and a forward speed of a tow vehicle or said trailer;
determining if said detected lateral motion variable exceeds a predetermined allowable limit value specified for the detected forward speed;
applying a pressurized gas from a pressurized gas reservoir to the cylinder interior of a buffer arm attached to the said towed trailer thereby applying a force to counter said undesired lateral motion if said detected lateral motion variable exceeds said predetermined allowable limit value.

10. The method of claim 9, wherein when the detected forward speed exceeds 30 miles per hour (mph), the detected lateral motion variable is the yaw angle, φ, and the predetermined allowable limit value of φ is in the range of 10 to 45 degrees.

11. The method of claim 9, wherein the pressurized gas is air and the pressurized gas reservoir is pressurized by an air compressor.

12. The method of claim 9, wherein the step of detecting a lateral motion variable and a forward speed further comprises detecting a second lateral motion variable,

13. The method of claim 9, wherein a first lateral motion variable is lateral acceleration and a second lateral motion variable is either lateral velocity or the yaw angle φ.

14. The method of claim 9, wherein the step of determining if said detected lateral motion variable exceeds a predetermined allowable limit value specified for the detected forward speed is performed by a computer using a stored memory look-up table of data.

15. The method of claim 9, wherein the step of applying a pressurized gas is performed until a predetermined time interval after opening fluid communication between said pressurized gas reservoir and said cylinder interior has passed, at which time a valve is actuated to close and thereby terminate fluid communication between said pressurized gas reservoir and said cylinder interior.

16. The method of claim 9, wherein the step of applying a pressurized gas is performed until a predetermined pressure is detected in either said cylinder interior or in a gas line connected to said cylinder interior.

17. The method of claim 9, comprising the further subsequent step of actuating a valve to vent gas from said cylinder interior and an attached gas line to the ambient atmosphere.

18. A kit comprising: at least one buffer arm, a computer, a valve block, a pressurized or pressurizable gas reservoir, at least one gas line, a computer, and a sensor.

19. A kit of claim 18, further comprising a second buffer arm and a second gas line.

20. The kit of claim 18, further comprising at least one attachable pivotable attachment point selected from the group consisting of: an attachable pivotable trailer attachment points and an attachable pivotable tow vehicle attachment point.
